(19) United States
(12) Patent Application Publication
(10) Pub. No.: US 2025/0362033 A1
(43) Pub. Date: Nov. 27, 2025

(54) CO-GENERATION SYSTEM FOR HEATING APPLICATION

(71) Applicant: Caterpillar Inc., Peoria, IL (US)

(72) Inventors: Prakash Prashanth Ravi, Bengaluru (IN); Krishna Prasath Ramabadhran, Krishnagiri (IN)

(73) Assignee: Caterpillar Inc., Peoria, IL (US)

(21) Appl. No.: 18/672,131

(22) Filed: May 23, 2024

(51) Int. Cl. F24D 13/04; H02J 7/00

(52) U.S. Cl. CPC F24D 13/04; H02J 7/007192; F24D 2200/29

(57) ABSTRACT

A co-generation system for heating an application includes an energy storage system that dissipates heat upon operation thereof. The co-generation system also includes a first heat exchanger in thermal contact with the energy storage system. A coolant flowing through the first heat exchanger extracts the heat generated by the energy storage system. The co-generation system further includes a second heat exchanger in thermal contact with the application. The second heat exchanger receives the coolant from the first heat exchanger. The coolant flowing through the second heat exchanger exchanges heat with air in the application to at least partially heat the application. The co-generation system includes a first controller communicably coupled with the energy storage system. The first controller is configured to receive a heating requirement of the application and control one or more operating conditions of the energy storage system in order to meet the heating requirement of the application.

### TECHNICAL FIELD

The present disclosure relates to a co-generation system for heating an application, a system for heating the application using an energy storage system, and a method for heating the application using the energy storage system.

### BACKGROUND

In cold regions, it is required to heat enclosed spaces, for example, those inside a residential or commercial building, in order to maintain habitable conditions within such enclosed spaces. In other examples, heat supply may also be required in industrial applications to perform one or more work operations, such as heating, drying, and the like. Typically, in order to provide the heat supply, a heating, ventilation, and air conditioning (HVAC) system is incorporated that includes one or more heaters. Such HVAC systems require additional power or resources for generating heat, which consume significant energy and increase day-to-day operating costs. For example, the HVAC system may include electric heaters that may require significant energy to operate.

It may be advantageous to reduce operating costs associated with HVAC systems, reduce dependency on energy sources, and operate the HVAC systems using sources that otherwise reject heat to the atmosphere.

CN109084395A describes a running method for reducing the building energy consumption and an integrated building structure and aims at providing a method and system capable of conducting cross-season energy accumulation in a targeted manner according to the season characteristics so as to increase the energy utilization rate. According to the method, in a heat collecting and isolating mode, when the outdoor comprehensive temperature is 25-35 DEG C, an energy accumulating system exchanges heat with a first heat exchange system; when the outdoor comprehensive temperature is larger than 35 DEG C, the energy accumulating system exchanges heat with the first heat exchange system and a second heat exchange system, and sun radiation heat absorbed by the first heat exchange system and the second heat exchange system is brought away and stored in the energy accumulating system. In a cold collecting heat preservation mode, when the outdoor comprehensive temperature is 5-15 DEG C, the energy accumulating system exchanges heat with the second heat exchange system, and when the outdoor comprehensive temperature is lower than 5 DEG C, the energy accumulating system exchanges heat with the first heat exchange system and the second heat exchange system, the cooling capacity of the first heat exchange system and the second heat exchange system is brought away and stored in the energy accumulating system. By means of the running method, the energy utilization rate can be greatly increased.

### SUMMARY OF THE DISCLOSURE

In an aspect of the present disclosure, a co-generation system for heating an application is provided. The co-generation system includes an energy storage system including one or more battery modules. The energy storage system dissipates heat upon operation thereof. The co-generation system also includes a first heat exchanger in thermal contact with the energy storage system. A coolant flowing through the first heat exchanger extracts the heat generated by the energy storage system. The co-generation system further includes a second heat exchanger in thermal contact with the application. The second heat exchanger receives the coolant from the first heat exchanger. The coolant flowing through the second heat exchanger exchanges heat with air in the application to at least partially heat the application. The co-generation system includes a first controller communicably coupled with the energy storage system. The first controller is configured to receive a heating requirement of the application. The first controller is also configured to control one or more operating conditions of the energy storage system in order to meet the heating requirement of the application.

In another aspect of the present disclosure, a system for heating an application using an energy storage system is provided. The energy storage system includes one or more battery modules. The energy storage system is in thermal contact with a first heat exchanger. The application is in thermal contact with a second heat exchanger. The system includes a flow control valve that provides selective fluid communication between the first heat exchanger and the second heat exchanger. The flow control valve receives a coolant exiting the first heat exchanger after extracting heat generated by the energy storage system. In an open state of the flow control valve, the flow control valve directs the coolant received from the first heat exchanger towards the second heat exchanger. The coolant flowing through the second heat exchanger exchanges heat with air in the application to at least partially heat the application. The system also includes a first controller communicably coupled with the energy storage system and the flow control valve. The first controller is configured to receive a heating requirement of the application. The first controller is also configured to control one or more operating conditions of the energy storage system in order to meet the heating requirement of the application. The first controller is further configured to control an operation of the flow control valve to direct the coolant from the first heat exchanger to the second heat exchanger based on the heating requirement of the application.

In yet another aspect of the present disclosure, a method of heating an application using an energy storage system is provided. The energy storage system includes one or more battery modules. The energy storage system is in thermal contact with a first heat exchanger. The application is in thermal contact with a second heat exchanger. The method includes receiving, by a first controller, a heating requirement of the application. The first controller is communicably coupled with the energy storage system. The method also includes controlling, by the first controller, one or more operating conditions of the energy storage system in order to meet the heating requirement of the application. The method further includes increasing a temperature of a coolant flowing through the first heat exchanger based on a heat exchange between the coolant and heat dissipated by the energy storage system. The method includes controlling, by the first controller, an operation of a flow control valve to direct the coolant from the first heat exchanger to the second heat exchanger based on the heating requirement of the application. The flow control valve provides selective fluid communication between the first heat exchanger and the second heat exchanger. The flow control valve receives the coolant exiting the first heat exchanger after extracting heat generated by the energy storage system. The method also includes directing, by the flow control valve, the coolant received from the first heat exchanger towards the second heat exchanger. The method further includes heating, at least partially, the application based on a heat exchange between the coolant flowing through the second heat exchanger and air in the application.

Other features and aspects of this disclosure will be apparent from the following description and the accompanying drawings.

### BRIEF DESCRIPTION OF THE DRAWINGS

FIG. 1 is a schematic block diagram of a co-generation system for heating an application using an energy storage system, according to an example of the present disclosure;

FIG. 2 is a schematic block diagram of a system for heating the application, according to an example of the present disclosure; and

FIG. 3 is a flowchart of a method of heating the application using the energy storage system, according to an example of the present disclosure.

### DETAILED DESCRIPTION

Wherever possible, the same reference numbers will be used throughout the drawings to refer to the same or like parts.

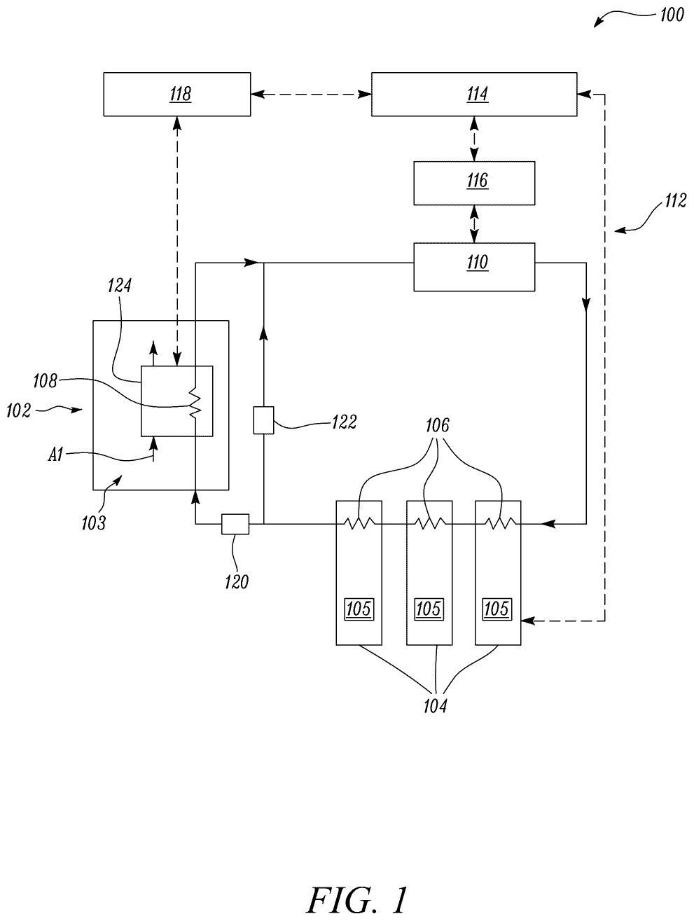

Referring to FIG. 1, a schematic block diagram of an exemplary co-generation system 100 for heating an application 102 is illustrated. In some examples, the application 102 may include a space inside a residential building, a commercial space, an industrial space, a component, a heating equipment, a control room, and the like, that may require heating. The application 102 described herein includes an enclosed space 103. It should be noted that the enclosed space 103 may be associated with any application, without any limitations. For example, in cold climate areas, the enclosed space 103 may require heating, to maintain a temperature inside the application 102 within desirable limits.

The co-generation system 100 includes an energy storage system 104 including one or more battery modules 105. The energy storage system 104 may store an electrical energy received from any known electrical system. The battery modules 105 of the energy storage system 104 may store the electrical energy therein. The energy storage system 104 may selectively direct the stored electrical energy for various residential, commercial, and/or industrial applications.

The co-generation system 100 may include any number of energy storage systems 104. For example, as shown in FIG. 1, the co-generation system 100 includes a first energy storage system 104, a second energy storage system 104, and a third energy storage system 104. The co-generation system 100 may include n-number of energy storage systems 104. In some examples, each energy storage system 104 may have a different configuration and may be rated for a different power and energy capacity. In other examples, each energy storage system 104 may have a same configuration and may be rated for same power and energy capacity. Further, each energy storage system 104 may have a different state of charge or each energy storage system 104 may have the same state of charge. The first energy storage system 104, the second energy storage system 104, and the third energy storage system 104 are hereinafter interchangeably referred to as “energy storage system 104”. The energy storage system 104 dissipates heat upon operation thereof. In an example, the energy storage system 104 dissipates heat due to flow of current through the battery modules 105 of the energy storage system 104. Further, each energy storage system 104 includes one or more power electronics, such as, switches, capacitors, converters, and/or inverters that generate heat upon operation.

The co-generation system 100 also includes a first heat exchanger 106 in thermal contact with the energy storage system 104. A coolant flowing through the first heat exchanger 106 extracts the heat generated by the energy storage system 104. The coolant may be any fluid that may exchange heat. For example, the coolant may be water.

The first heat exchanger 106 is disposed in the energy storage system 104. The first heat exchanger 106 is embodied as a cooling device that is used to maintain a temperature of the energy storage system 104 within predefined temperature limits. The first heat exchanger 106 may embody any conventional heat exchanger that is used to cool components or spaces based on a heat exchange between the coolant flowing through the first heat exchanger 106 and heat generated by the components or spaces. In some examples, the first heat exchanger 106 may include a tube that runs across the energy storage system 104 and receives the coolant therein. It should be noted that the coolant entering the first heat exchanger 106 has a lower temperature, and the coolant exiting the first heat exchanger 106 has a higher temperature.

The co-generation system 100 further includes a second heat exchanger 108 in thermal contact with the application 102. In an example, the second heat exchanger 108 is a part of a heating, ventilation, and air conditioning (HVAC) system 124 that is in thermal contact with the application 102 and maintains the temperature of the application 102 within desired limits. The second heat exchanger 108 is disposed in the application 102, and specifically, in the enclosed space 103. The second heat exchanger 108 is embodied as a heating device that is used to heat the enclosed space 103 to maintain a temperature of the enclosed space 103 within desired limits. The second heat exchanger 108 may embody any conventional heat exchanger that is used to heat components or spaces based on a heat exchange between a high-temperature liquid flowing through the second heat exchanger 108 and air A1. The second heat exchanger 108 receives the coolant from the first heat exchanger 106. The coolant flowing through the second heat exchanger 108 exchanges heat with air A1 in the application 102 to at least partially heat the application 102. It should be noted that the coolant entering the second heat exchanger 108 has a higher temperature, and the coolant exiting the second heat exchanger 108 has a lower temperature.

In some examples, the second heat exchanger 108 may solely heat the application 102 based on heat exchange between the coolant and the air A1 in the enclosed space 103. In other examples, wherein the heat exchange between the coolant and the air A1 in the enclosed space 103 is not sufficient to heat the enclosed space 103, the HVAC system 124 of the enclosed space 103 may additionally include a heater. In such examples, the heater and the second heat exchanger 108 may together facilitate heating of the enclosed space 103.

The co-generation system 100 further includes a chiller 110 in fluid communication with the first heat exchanger 106 or the second heat exchanger 108. The chiller 110 receives the coolant from the first heat exchanger 106 or the second heat exchanger 108. The chiller 110 operates to reduce a temperature of the coolant flowing therethrough. The chiller 110 directs the coolant towards the first heat exchanger 106 to meet a cooling requirement of the energy storage system 104. Thus, the chiller 110 cools the coolant so that the temperature of the coolant that is directed to the energy storage system 104 is suitable to cool the energy storage system 104. The chiller 110 may include a heat exchanger (not shown) to facilitate a heat exchange between the coolant and a cooling fluid. The cooling fluid may flow through the heat exchanger to cool the coolant. A temperature of the cooling fluid may be controlled based on the cooling requirement of the energy storage system 104. The chiller 110 may further include a control valve (not shown) that controls a flow rate of the coolant that is directed towards the first heat exchanger 106.

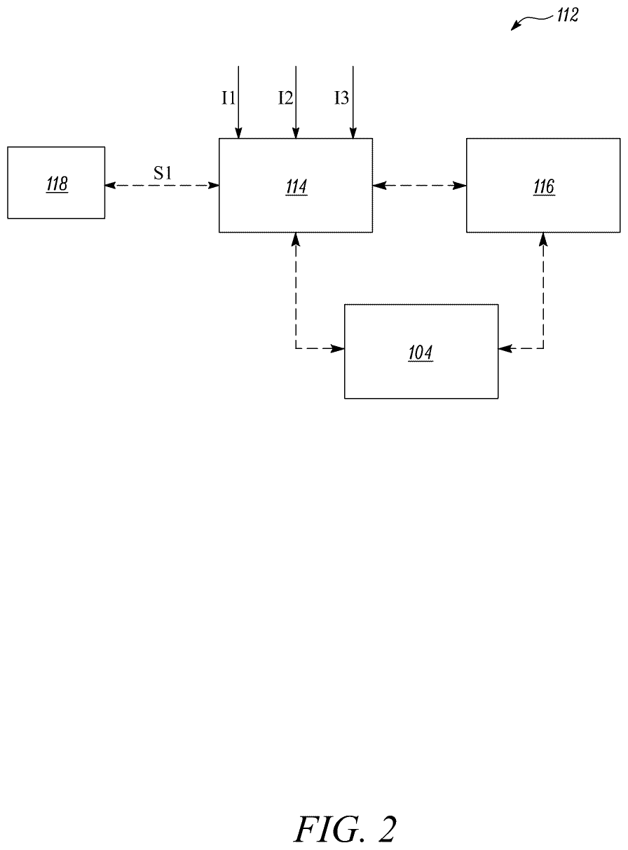

Referring to FIG. 2, a schematic block diagram of a system 112 for heating the application 102 (see FIG. 1) using the energy storage system 104 is illustrated. In the present disclosure, the system 112 is shown as a part of the co-generation system 100 (see FIG. 1). In other words, the co-generation system 100 includes the system 112. Alternatively, the system 112 may be associated with any other conventional energy storage system and application.

In FIGS. 1 and 2, solid lines represent fluid communication between components and dotted lines represent communicable coupling between the components. With reference to FIGS. 1 and 2, the system 112 includes a first controller 114 communicably coupled with the energy storage system 104. The first controller 114 monitors and controls an operation of the energy storage system 104. The first controller 114 may control an output of the energy storage system 104 as per application requirements. The first controller 114 receives a heating requirement of the application 102. Specifically, the system 112 includes a third controller 118 communicably coupled with the first controller 114 and the second heat exchanger 108. The third controller 118 transmits a signal S1 indicative of the heating requirement of the application 102 to the first controller 114. Thus, the third controller 118 determines the heating requirement of the application 102. The third controller 118 may receive a target temperature requirement of the application 102. Further, the third controller 118 may be in communication with one or more sensors present in the enclosed space 103. Such sensors may generate signals relative to a current temperature in the enclosed space 103. The third controller 118 may determine the heating requirement based on a comparison between the current temperature within the enclosed space 103 and the target temperature requirement of the enclosed space 103.

The first controller 114 controls one or more operating conditions of the energy storage system 104 in order to meet the heating requirement of the application 102. In an example, the one or more operating conditions of the energy storage system 104 includes a C-rate of the battery modules 105 (see FIG. 1) of the energy storage system 104. As the heat generated by the energy storage system 104 may depend on an internal resistance of the battery modules 105 and a current flowing through the battery modules 105, by increasing the C-rate, i.e., a discharge capacity of the battery modules 105, the amount of heat generated by the energy storage system 104 may increase. Thus, the first controller 114 increases the C-rate of the battery modules 105 based on an increase in the heating requirement of the application 102. The increase in the C-rate of the battery modules 105 increases an amount of the heat dissipated by the energy storage system 104. As used herein the term “C-rate” of the battery modules 105 is defined as a rate of time that the battery modules 105 take to charge or discharge.

In some examples, the first controller 114 receives a first input I1, a second input I2, and a third input I3. The first input I1 indicates a state of charge of each battery module 105 of the energy storage system 104. The second input I2 indicates a state of health of each battery module 105 of the energy storage system 104. The third input I3 indicates a demand of electric power from a power grid (not shown). The first controller 114 increases the C-rate i.e., the discharge capacity of the battery modules of the energy storage system 104 based on the inputs I1, I2, and I3 to increase the amount of heat dissipated by the energy storage system 104.

The system 112 further includes a second controller 116 communicably coupled with the first controller 114 and the chiller 110. The second controller 116 is a thermal management controller that controls the chiller 110 to maintain the temperature of the energy storage system 104 within the predefined temperature limits. The second controller 116 controls the chiller 110 to vary one or more parameters of the coolant that is directed towards the first heat exchanger 106 based on the cooling requirement of the energy storage system 104. In some examples, the one or more parameters of the coolant includes the temperature of the coolant that is directed towards the first heat exchanger 106 and/or the flow rate of the coolant that is directed towards the first heat exchanger 106.

Further, each of the first controller 114, the second controller 116, and the third controller 118 may include one or more memories and one or more processors. The one or more memories may include any means of storing information, including a hard disk, an optical disk, a floppy disk, ROM (read only memory), RAM (random access memory), PROM (programmable ROM), EEPROM (electrically erasable PROM), or other computer-readable memory media.

It should be noted that the one or more processors may embody a single microprocessor or multiple microprocessors for receiving various input signals and generating output signals. Numerous commercially available microprocessors may perform the functions of the one or more processors. Each processor may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor may include one or more components that may be operable to execute computer executable instructions or computer code that may be stored and retrieved from the one or more memories.

The system 112 further includes a flow control valve 120 that provides selective fluid communication between the first heat exchanger 106 and the second heat exchanger 108. The first controller 114 is communicably coupled with the flow control valve 120. The first controller 114 controls an operation of the flow control valve 120 to direct the coolant from the first heat exchanger 106 to the second heat exchanger 108 based on the heating requirement of the application 102. The first controller 114 switches the flow control valve 120 between an open state and a closed state. The first controller 114 operates the flow control valve 120 in the open state when the enclosed space 103 requires heating. For example, the first controller 114 operates the flow control valve 120 in the open state to direct the coolant from the first heat exchanger 106 towards the second heat exchanger 108 if the heating requirement of the application 102 is above a predetermined temperature threshold. The predetermined temperature threshold may be set by users of the application 102.

Further, the first controller 114 operates the flow control valve 120 in the closed state when the enclosed space 103 does not require heating. For example, the first controller 114 operates the flow control valve 120 in the closed state to prevent the flow of the coolant from the first heat exchanger 106 towards the second heat exchanger 108 if the heating requirement of the application 102 is below the predetermined temperature threshold. In some examples, the flow control valve 120 may include a solenoid valve. It should be noted that, the chiller 110 receives the coolant from the second heat exchanger 108 when the coolant flows through the flow control valve 120.

The system 112 also includes a bypass valve 122 that provides selective fluid communication between the first heat exchanger 106 and the chiller 110. The first controller 114 is communicably coupled with the bypass valve 122. The first controller 114 operates the bypass valve 122 in an open state to direct the coolant from the first heat exchanger 106 towards the chiller 110 if the heating requirement of the application 102 is below the predetermined temperature threshold. In some examples, the bypass valve 122 may include a solenoid valve. It should be noted that, the chiller 110 receives the coolant directly from the first heat exchanger 106 when the coolant flows through the bypass valve 122.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the co-generation system 100 wherein the heat dissipated from multiple energy storage systems 104 is used to heat the application 102, while saving energy, reducing energy consumption by the second heat exchanger 108, and also reducing a load on the chiller 110.

The co-generation system 100 includes the first heat exchanger 106 which provides heat exchange between the coolant and the heat that is dissipated from the energy storage system 104. The co-generation system 100 may ensure an efficient operation of the energy storage system 104 and may also ensure that the energy storage system 104 operates within the predefined temperature limits. Further, the co-generation system 100 may be used as a source of heating the application 102 during low electrical demand, thereby effectively utilizing the energy storage system 104 during low electrical demand.

The co-generation system 100 further includes the second heat exchanger 108 that receives the coolant from the first heat exchanger 106. The coolant flowing through the second heat exchanger 108 exchanges heat with the air A1 in the application 102 to at least partially heat the application 102. The co-generation system 100 may increase an efficiency of the HVAC system 124 associated with the enclosed space 103, while reducing an energy consumption of the HVAC system 124. The co-generation system 100 may reduce a dependability of the HVAC system 124 on electrical heaters to heat the application 102, thereby reducing consumption of electrical power.

The co-generation system 100 further includes the chiller 110 that receives the coolant from the second heat exchanger 108 and operates to reduce the temperature of the coolant to meet the cooling requirement of the energy storage system 104. The co-generation system 100 may reduce load on the chiller 110. Specifically, the coolant received in the chiller 110 is at a lower temperature based on the heat exchange between the coolant and the air Al in the second heat exchanger 108, thereby reducing the load on the chiller 110. Moreover, the co-generation system 100 may increase thermal management efficiency of the energy storage system 104.

Overall, the co-generation system 100 may enable optimum heating of the application 102 as well as provide an optimum supply of electricity on a real time basis, based on incorporation of the first, second, and third controllers 114, 116, 118. Furthermore, the first, second, and third controllers 114, 116, 118 may already be present with the respective energy storage system 104 and the HVAC system 124, thus the system 112 may be simple and cost-effective to implement.

The co-generation system 100 may be retrofitted in buildings, offices, industries, and the like that are present proximal to the energy storage system 104. Moreover, the co-generation system 100 may reduce cost and complexity associated with heating of the application 102 and cooling of the energy storage system 104.

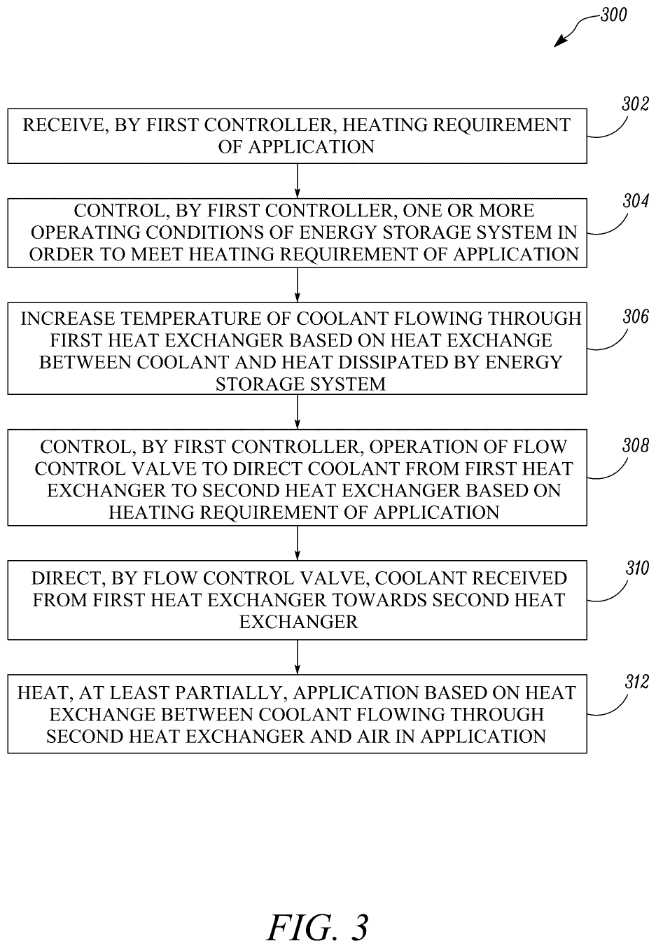

FIG. 3 is a flowchart of a method 300 of heating the application 102 using the energy storage system 104. The energy storage system 104 includes the one or more battery modules 105. The energy storage system 104 is in thermal contact with the first heat exchanger 106. The application 102 is in thermal contact with the second heat exchanger 108.

At step 302, the first controller 114 receives the heating requirement of the application 102. The first controller 114 is communicably coupled with the energy storage system 104.

At step 304, the first controller 114 controls the one or more operating conditions of the energy storage system 104 in order to meet the heating requirement of the application 102. The one or more operating conditions of the energy storage system 104 includes the C-rate of the battery modules 105 of the energy storage system 104. The step 304 of controlling the one or more operating conditions of the energy storage system 104 further includes increasing the C-rate of the battery modules 105 by the first controller 114 based on the increase in the heating requirement of the application 102. The increase in the C-rate increases the amount of the heat dissipated by the energy storage system 104.

At step 306, the temperature of the coolant flowing through the first heat exchanger 106 is increased based on the heat exchange between the coolant and the heat dissipated by the energy storage system 104.

At step 308, the first controller 114 controls the operation of the flow control valve 120 to direct the coolant from the first heat exchanger 106 to the second heat exchanger 108 based on the heating requirement of the application 102. The flow control valve 120 provides selective fluid communication between the first heat exchanger 106 and the second heat exchanger 108. The flow control valve 120 receives the coolant exiting the first heat exchanger 106 after extracting the heat generated by the energy storage system 104.

At step 310, the flow control valve 120 directs the coolant received from the first heat exchanger 106 towards the second heat exchanger 108.

At step 312, the application 102 is at least partially heated based on the heat exchange between the coolant flowing through the second heat exchanger 108 and the air Al in the application 102.

The method 300 further includes a step at which the third controller 118 transmits the signal S1 indicative of the heating requirement of the application 102 to the first controller 114. The third controller 118 is communicably coupled with the first controller 114 and the second heat exchanger 108.

Further, the chiller 110 is in fluid communication with the first heat exchanger 106 or the second heat exchanger 108. The chiller 110 receives the coolant from the first heat exchanger 106 or the second heat exchanger 108. The method 300 includes a step at which the chiller 110 is operated to reduce the temperature of the coolant flowing therethrough. The method 300 further includes a step at which the chiller 110 directs the coolant towards the first heat exchanger 106 to meet the cooling requirement of the energy storage system 104.

The method 300 further includes a step at which the second controller controls the chiller 110 to vary the one or more parameters of the coolant that is directed towards the first heat exchanger 106 based on the cooling requirement of the energy storage system 104. The second controller 116 is communicably coupled with the first controller 114 and the chiller 110. The one or more parameters of the coolant includes the temperature of the coolant that is directed towards the first heat exchanger 106 and/or the flow rate of the coolant that is directed towards the first heat exchanger 106.

The method 300 further includes a step at which the first controller 114 operates the bypass valve 122 in the open state to direct the coolant from the first heat exchanger 106 towards the chiller 110 if the heating requirement of the application 102 is below the predetermined temperature threshold. The bypass valve 122 provides selective fluid communication between the first heat exchanger 106 and the chiller 110. The first controller 114 is communicably coupled with the bypass valve 122.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A co-generation system for heating an application, the co-generation system comprising:
an energy storage system including one or more battery modules, wherein the energy storage system dissipates heat upon operation thereof;
a first heat exchanger in thermal contact with the energy storage system, wherein a coolant flowing through the first heat exchanger extracts the heat generated by the energy storage system;
a second heat exchanger in thermal contact with the application, wherein the second heat exchanger receives the coolant from the first heat exchanger, and wherein the coolant flowing through the second heat exchanger exchanges heat with air in the application to at least partially heat the application; and
a first controller communicably coupled with the energy storage system, wherein the first controller is configured to:
receive a heating requirement of the application; and
control one or more operating conditions of the energy storage system in order to meet the heating requirement of the application.

2. The co-generation system of claim 1, wherein the one or more operating conditions of the energy storage system includes a C-rate of the battery modules of the energy storage system, wherein the first controller is configured to increase the C-rate of the energy storage system based on an increase in the heating requirement of the application, and wherein the increase in the C-rate of the battery modules increases an amount of the heat dissipated by the energy storage system.

3. The co-generation system of claim 1 further comprising a chiller in fluid communication with at least one of the first heat exchanger and the second heat exchanger, wherein the chiller receives the coolant from at least one of the first heat exchanger and the second heat exchanger, wherein the chiller operates to reduce a temperature of the coolant flowing therethrough, and wherein the chiller directs the coolant towards the first heat exchanger to meet a cooling requirement of the energy storage system.

4. The co-generation system of claim 3 further comprising a second controller communicably coupled with the first controller and the chiller, wherein the second controller is configured to control the chiller to vary one or more parameters of the coolant that is directed towards the first heat exchanger based on the cooling requirement of the energy storage system.

5. The co-generation system of claim 4, wherein the one or more parameters of the coolant includes at least one of a temperature of the coolant that is directed towards the first heat exchanger and a flow rate of the coolant that is directed towards the first heat exchanger.

6. The co-generation system of claim 3 further comprising a bypass valve that provides selective fluid communication between the first heat exchanger and the chiller, wherein the first controller is communicably coupled with the bypass valve, and wherein the first controller is configured to operate the bypass valve in an open state to direct the coolant from the first heat exchanger towards the chiller if the heating requirement of the application is below a predetermined temperature threshold.

7. The co-generation system of claim 1 further comprising a third controller communicably coupled with the first controller and the second heat exchanger, wherein the third controller is configured to transmit a signal indicative of the heating requirement of the application to the first controller.

8. The co-generation system of claim 1 further comprising a flow control valve that provides selective fluid communication between the first heat exchanger and the second heat exchanger, wherein the first controller is communicably coupled with the flow control valve, and wherein the first controller is configured to control an operation of the flow control valve to direct the coolant from the first heat exchanger to the second heat exchanger based on the heating requirement of the application.

9. A system for heating an application using an energy storage system, wherein the energy storage system includes one or more battery modules, wherein the energy storage system is in thermal contact with a first heat exchanger, and wherein the application is in thermal contact with a second heat exchanger, the system comprising:
a flow control valve that provides selective fluid communication between the first heat exchanger and the second heat exchanger, wherein the flow control valve receives a coolant exiting the first heat exchanger after extracting heat generated by the energy storage system, wherein, in an open state of the flow control valve, the flow control valve directs the coolant received from the first heat exchanger towards the second heat exchanger, and wherein the coolant flowing through the second heat exchanger exchanges heat with air in the application to at least partially heat the application; and
a first controller communicably coupled with the energy storage system and the flow control valve, wherein the first controller is configured to:
receive a heating requirement of the application;
control one or more operating conditions of the energy storage system in order to meet the heating requirement of the application; and
control an operation of the flow control valve to direct the coolant from the first heat exchanger to the second heat exchanger based on the heating requirement of the application.

10. The system of claim 9, wherein the one or more operating conditions of the energy storage system includes a C-rate of the battery modules of the energy storage system, wherein the first controller is configured to increase the C-rate of the battery modules based on an increase in the heating requirement of the application, and wherein the increase in the C-rate increases an amount of the heat dissipated by the energy storage system.

11. The system of claim 9, wherein a chiller is in fluid communication with at least one of the first heat exchanger and the second heat exchanger, wherein the chiller receives the coolant from at least one of the first heat exchanger and the second heat exchanger, wherein the chiller operates to reduce a temperature of the coolant flowing therethrough, and wherein the chiller directs the coolant towards the first heat exchanger to meet a cooling requirement of the energy storage system.

12. The system of claim 11 further comprising a second controller communicably coupled with the first controller and the chiller, wherein the second controller is configured to control the chiller to vary one or more parameters of the coolant that is directed towards the first heat exchanger based on the cooling requirement of the energy storage system.

13. The system of claim 11 further comprising a bypass valve that provides selective fluid communication between the first heat exchanger and the chiller, wherein the first controller is communicably coupled with the bypass valve, and wherein the first controller is configured to operate the bypass valve in an open state to direct the coolant from the first heat exchanger towards the chiller if the heating requirement of the application is below a predetermined temperature threshold.

14. The system of claim 9 further comprising a third controller communicably coupled with the first controller and the second heat exchanger, wherein the third controller is configured to transmit a signal indicative of the heating requirement of the application to the first controller.

15. A method of heating an application using an energy storage system, wherein the energy storage system includes one or more battery modules, wherein the energy storage system is in thermal contact with a first heat exchanger, and wherein the application is in thermal contact with a second heat exchanger, the method comprising:
receiving, by a first controller, a heating requirement of the application, wherein the first controller is communicably coupled with the energy storage system;
controlling, by the first controller, one or more operating conditions of the energy storage system in order to meet the heating requirement of the application;
increasing a temperature of a coolant flowing through the first heat exchanger based on a heat exchange between the coolant and heat dissipated by the energy storage system;
controlling, by the first controller, an operation of a flow control valve to direct the coolant from the first heat exchanger to the second heat exchanger based on the heating requirement of the application, wherein the flow control valve provides selective fluid communication between the first heat exchanger and the second heat exchanger, and wherein the flow control valve receives the coolant exiting the first heat exchanger after extracting heat generated by the energy storage system;
directing, by the flow control valve, the coolant received from the first heat exchanger towards the second heat exchanger; and
heating, at least partially, the application based on a heat exchange between the coolant flowing through the second heat exchanger and air in the application.

16. The method of claim 15, wherein the one or more operating conditions of the energy storage system includes a C-rate of the battery modules of the energy storage system, wherein the step of controlling the one or more operating conditions of the energy storage system further includes increasing, by the first controller, the C-rate of the battery modules based on an increase in the heating requirement of the application, and wherein the increase in the C-rate increases an amount of the heat dissipated by the energy storage system.

17. The method of claim 15, wherein a chiller is in fluid communication with at least one of the first heat exchanger and the second heat exchanger, and wherein the chiller receives the coolant from at least one of the first heat exchanger and the second heat exchanger, the method further comprising:
operating the chiller to reduce a temperature of the coolant flowing therethrough; and
directing, by the chiller, the coolant towards the first heat exchanger to meet a cooling requirement of the energy storage system.

18. The method of claim 17 further comprising controlling, by a second controller, the chiller to vary one or more parameters of the coolant that is directed towards the first heat exchanger based on the cooling requirement of the energy storage system, wherein the second controller is communicably coupled with the first controller and the chiller, and wherein the one or more parameters of the coolant includes at least one of a temperature of the coolant that is directed towards the first heat exchanger and a flow rate of the coolant that is directed towards the first heat exchanger.

19. The method of claim 17 further comprising operating, by the first controller, a bypass valve in an open state to direct the coolant from the first heat exchanger towards the chiller if the heating requirement of the application is below a predetermined temperature threshold, wherein the bypass valve provides selective fluid communication between the first heat exchanger and the chiller, and wherein the first controller is communicably coupled with the bypass valve.

20. The method of claim 15 further comprising transmitting, by a third controller, a signal indicative of the heating requirement of the application to the first controller, wherein the third controller is communicably coupled with the first controller and the second heat exchanger.
